(19) United States
(12) Patent Application Publication
(10) Pub. No.: US 2009/0169087 A1
(43) Pub. Date: Jul. 2, 2009

(54) METHOD FOR DETECTION OF VERTEBRAL FRACTURES ON LATERAL CHEST RADIOGRAPHS

(76) Inventors: Kunio Doi, Willowbrook, IL (US); Satoshi Kasai, Willowbrook, IL (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/280,697

(22) PCT Filed: Sep. 19, 2006
(86) PCT No.: PCT/US2006/036516

§ 371 Date: Aug. 26, 2008

Related U.S. Application Data
(60) Provisional application No. 60/785,384, filed on Mar. 24, 2006.

(51) Int. Cl. G06K 9/00

(52) U.S. Cl. 382/132

(57) ABSTRACT

A method, system, and computer program product for detecting vertebral fractures, including steps of (1) obtaining a medical image including a plurality of vertebrae; (2) detecting, corresponding edges of the plurality of vertebra using line enhancement and feature analysis; (3) determining the vertebral height of each vertebra based on a location of the detected edges of the vertebra; and (4) analyzing the determined vertebral heights to identify fractured vertebra.

### STATEMENT REGARDING FEDERALLY SPONSORED RESEARCH

The present invention was made in part with U.S. Government support under USPHS Grant Nos. CA062625 and CA098119. The U.S. Government may have certain rights to this invention.

### BACKGROUND OF THE INVENTION

### Field of the Invention

The present invention relates generally to the automated detection of vertebral fractures in medical images, and more particularly to methods, systems, and computer program products for the detection of vertebral fractures in medical images (such as MRA images) using quantitative analysis of vertebral edges that are visible on lateral chest radiographs.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,832,103; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,138,045; 6,141,437; 6,185,320; 6,205,348; 6,240,201; 6,282,305; 6,282,307; 6,317,617; 6,466,689; 6,363,163; 6,442,287; 6,335,980; 6,594,378; 6,470,092; 6,483,934; as well as U.S. patent application Ser. Nos. 08/398,307; 09/759,333; 09/760,854; 09/773,636; 09/816,217; 09/830,562; 09/818,831; 09/860,574; 10/270,674; 09/990,311; 09/990,310; 09/990,377; 10/078,694; 10/079,820; 10/120,420; 10/126,523; 10/301,836; 10/355,147; 10/360,814; 10/366,482; all of which are incorporated herein by reference.

The present invention includes the use of various technologies referenced and described in the above-noted U.S. Patents and Applications, as well as described in the documents identified in the following LIST OF REFERENCES, which are cited throughout the specification by the corresponding reference number in brackets:

### LIST OF REFERENCES

(1) N. F. Ray, J. K. Chan, M. Thamer et al “Medical expenditures for the treatment of osteoporotic fractures in the United States in 1995: report from the National Osteoporosis Foundation,” J Bone Miner Res 12: 24-35 (1997).
(2) M. Lunt, D. Felsenberg, J. Reeve et al. “Bone density variation and its effects on risk of vertebral deformity in men and women studied in thirteen European centers: the EVOS study,” J Bone Miner Res 12: 1883-1894 (1997).
(3) The European Prospective Osteoporosis Study (EPOS) group “Incidence of vertebral fracture in Europe: results from the European Prospective Osteoporosis Study (EPOS),” J Bone Miner Res 17: 716-724 (2002).
(4) J. D. Adachi, G. Ioannidis, L. Pickard et al. “The association between osteoporotic fractures and health-related quality of life as measured by the Health Utilities Index in the Canadian Multicentre Osteoporosis study (CaMos),” Osteoporos Int. 14: 895-904 (2003).
(5) H. Jinbayashi, K. Aoyagi, P. D. Ross et al. “Provalence of vertebral deformity and its associations with physical impairment among Japanese women: the Hizen-Oshima study,” Osteoporos Int 13: 723-730 (2002).
(6) C. M. Klotzbuecher, P. D. Ross, P. B. Landsman et al. “Patients with prior fractures have an increased risk of future fractures: a summary of the literature and statistical synthesis,” J Bone Miner Res 15: 721-739 (2000).
(7) D. M. Kado, W. S. Browner, L. Palermo et al. “Vertebral fractures and mortality in older women a prospective study,” Arch Intern Med 159: 1215-1220 (1999).
(8) U. A. Liberman, S. R. Weiss, J. Broll et al. “Effect of oral alendronate on bone mineral density and the incidence of fractures in postmenopausal osteoporosis,” N Engl J Med 333: 1437-1443 (1995).
(9) D. M. Black, S. R. Cummings, D. B. Karpf et al. “Randomised trial of effect of alendronate on risk of fracture in women with existing vertebral fractures,” Lancet 348: 1535-1541(1996).
(10) C. H. Chesnut III, S. Silverman, K. Andriano et al. “A randomized trial of nasal spray salmon calcitonin in post-menopausal women with established osteoporosis: the Prevent Recurrence of Osteoporotic Fractures study,” Am J Med 109: 267-276 (2000).
(11) B. Ettinger, D. M. Black, B. H. Mitlak et al. “Reduction of vertebral fracture risk in postmenopausal women with osteoporosis treated with raloxifene Results from a 3-year randomized clinical trial,” JAMA 282: 637-645 (1999).
(12) N. Kim, B. H. Rowe, G. Raymond et al. “Underreporting of vertebral fractures on routine chest radiography,” AJR 182: 297-300 (2004).
(13) S. H. Gerlbach, C. Bigelow, M. Heimisdottir et al. “Recognition of vertebral fracture in a clinical setting,” Osteoporos Int. 11: 577-582 (2000).
(14) L. Lenchik, L. F. Rogers, P. D. Delmas et al. “Diagnosis of osteoporotic vertebral fractures: importance of recognition and description by radiologists,” AJR 183: 949-958 (2004).
(15) M. L. Giger, “Computerized analysis of images in the detection and diagnosis of breast cancer,” Seminars in ultrasound, CT and MRI 25(5): 411-418 (2004).
(16) H. P. Chan, K. Doi, C. J. Vyborny et al. “Improvement in radiologists' detection of clustered microcalcifications on mammograms—The potential of computer-aided diagnosis,” Invest Radiol 25: 1102-1110 (1990).
(17) Z. Huo, M. L. Giger, C. J. Vyborny et al. “Automated computerized classification of malignant and benign masses on digitized mammograms,” Acad Radiol 5: 155-168 (1998).
(18) T. W. Freer, M. J. Ulissey “Screening mammography with computer-aided detection: prospective study of 12,860 patients in a community breast center,” Radiology 220: 781-786 (2001).
(19) Suzuki K, Armato III S G, Li F, Sone S, and Doi K., Massive training artificial neural network (MTANN) for reduction of false positives in computerized detection of lung nodules in low-dose CT. Med Phys 2003; 30:1602-1617.
(20) S. V. Destounis, P. DiNitto, W. Logan-Young et al. “Can computer-aided detection with double reading of screening mammograms help decrease the false-negative rate? Initial experience,” Radiology 232: 578-584 (2004).
(21) R. L. Birdwell, P. Bandodkar, D. M. Ikeda “Computer-aided detection with screening mammography in a university hospital setting,” Radiology 236: 451-457 (2005).
(22) T. E. Cupples, J. E. Cunningham, J. C. Reynolds “Impact of computer-aided detection in a regional screening mammography program,” AJR 185: 944-950 (2005).
(23) M. L. Giger, K. Doi, H. MacMahon, “Pulmonary nodules: computer-aided detection in digital chest images,” RadioGraphics. 10: 41-51 (1990).
(24) X. W. Xu, K. Doi, T. Kobayashi et al. “Development of an improved CAD scheme for automated detection of lung nodules in digital chest images,” Med. Phys. 24: 1395-1403 (1997).
(25) T. Kobayashi, X. W. Xu, H. MacMahon et al. “Effect of a computer-aided diagnosis scheme on radiologists' performance in detection of lung nodules on radiographs,” Radiology 199: 843-848 (1996).
(26) H. Arimura, Q. Li, Y. Korogi et al. “Automated computerized scheme for detection of unruptured intracranial aneurysms in three-dimensional MRA,” Acad. Radiol. 11: 1093-1104 (2004).
(27) K . Doi, “Overview on research and development of computer-aided diagnostic schemes,” Seminars in Ultrasound, CT and MRI 25(5): 404-410 (2004).
(28) H. Yoshida, A. H. Dachman, “Computer-aided diagnosis for CT colonography,” Seminars in ultrasound, CT and MRI 25(5): 419-431 (2004).
(29) K. Doi, “Current status and future potential of computer-aided diagnosis in medical imaging,” British Journal of Radiology 78: S3-S19 (2005).
(30) H. K. Genant, C. Y. Wu, “Vertebral fracture assessment using a semiquantitative technique,” J Bone Miner Res 8: 1137-1148 (1993).
(31) C. G. Rafael, E. W. Richard. “Digital Image Processing,” Addison Wesley Publishing Company, 415-416 (1993).

The contents of each of these references, including the above-mentioned patents and patent applications, are incorporated herein by reference. The techniques disclosed in the patents, patent applications, and other references can be utilized as part of the present invention.

### Discussion of the Background

Osteoporosis is one of the major public health concerns in the world [1-7]. According to the annual report of the International Osteoporosis Foundation, one in three women and one in five men above the age of 50 years will experience an osteoporotic fracture. Several clinical trials have indicated clearly that pharmacologic therapy for osteoporosis by use of alendronate, salmon calcitonin nasal spray, and raloxifene is effective for persons who have had vertebral fractures, which are the hallmark of osteoporosis, to prevent subsequent fractures [8-11]. Liberman et al. [8] reported that alendronate increases the bone mineral density (BMD) and can reduce the risk of vertebral fractures in women who have low BMD. Black et al. [9] reported that, based on the Fracture Intervention Trial, alendronate substantially reduced the frequency of vertebral fractures and increased the BMD among women with low BMD who had vertebral fractures. Chesnut et al. [10] reported that salmon calcitonin nasal spray significantly reduced the risk of new vertebral fractures in a clinical trial at 42 centers in the United States and five centers in the United Kingdom. In the Multiple Outcomes of Raloxifene Evaluation study, Ettinger et al. [11] reported that the effectiveness of raloxifene for BMD and risk reduction of vertebral fracture was confirmed for 7,705 women at 180 centers in 25 countries. It is, therefore, important to diagnose vertebral fractures at an early stage.

Although most vertebral fractures are asymptomatic, they can often be detected on lateral chest radiographs which may have been obtained routinely for other purposes. However, investigators have noted that vertebral fractures which were visible on lateral chest radiographs were underdiagnosed or underreported [12,13]. Kim et al. [12] indicated that only 55% of vertebral fractures in randomly selected chest radiographs of patients aged 60 years or older who were examined in the emergency department of a tertiary care hospital were mentioned in the official radiology reports. Gehlbach et al. [13] indicated that, in studies on 934 women aged 60 years and older with chest radiographs, only 17% of identified vertebral fractures were noted in the medical record and discharge summary.

In a recent review paper by Lenchik et al.[14], published in AJR, the radiologists' role in the early detection of osteoporosis was strongly emphasized. For example, it is very important for radiologists to detect vertebral fractures on lateral chest radiographs and to report them for subsequent follow-up on the early detection of osteoporosis. Therefore, if vertebral fractures on lateral chest radiographs could be detected by computer, and if the locations of potential fractures were presented to radiologists as a “second opinion,” it would be possible to improve the detection of subtle vertebral fractures on lateral chest radiographs and thus the assessment of osteoporosis.

### SUMMARY OF THE INVENTION

Accordingly, one object of the present invention is to provide a method for detecting vertebral fractures in at least one medical image. In particular, one object of the present invention is to provide a computerized method for detection of vertebral fractures on lateral chest radiographs and to assist radiologists' image interpretation based on computer-aided diagnosis (CAD), which has been successful recently in the detection of breast cancers in mammography [15-22] and in other fields [23-29]. One embodiment of the present invention is based on the use of quantitative analysis of vertebral edges that are visible on lateral chest radiographs.

Accordingly, there is provided a method, system, and computer program product for detecting vertebral fractures, including (1) obtaining a medical image including a plurality of vertebrae; (2) extracting a vertebral area including the plurality of vertebra in the obtained medical image based on a determined posterior skinline; (3) detecting, in said vertebral area, corresponding edges of the plurality of vertebra using line enhancement and multiple thresholding; (4) determining the vertebral height of each vertebra based on a location of the detected edges of the vertebra; and (6) analyzing the determined vertebral heights to identify fractured vertebra.

In another embodiment of the present invention, the analyzing step comprises (1) determining a linear relationship between the determined vertebral heights and a location of each vertebra using least squares analysis; and (2) identifying the fractured vertebra as those vertebra having a height less than a predetermined percentage of an estimated height based on the determined linear relationship.

In another embodiment of the present invention, the analyzing step comprises (1) determining an anterior vertebral line, a middle vertebral line, and a posterior vertebral line based on the locations of the detected edges of the vertebra; (2) determining, for each vertebra, an anterior upper edge, an anterior lower edge, a middle upper edge, a middle lower edge, a posterior upper edge, and a posterior lower edge using the determined lines and the vertebral edges; (3) determining, for each vertebra, an anterior height (Ha), a middle height (Hm), and a posterior height (Hp) using the respective upper and lower edges; and (4) averaging, for each vertebra, the determined anterior height, middle height, and posterior height to obtain the vertebral height of the vertebra.

In another embodiment of the present invention, the analyzing step comprises (1) determining, for each vertebra, the ratios Ha/Hp, Hm/Hp, and Hp/average Hp, wherein average Hp is determined by averaging the determined posterior heights of adjacent vertebrae.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, in which like reference numerals refer to identical or corresponding parts throughout the several views, and in which:

FIG. 1 illustrates a computerized scheme for the detection of vertebral fractures on lateral chest radiographs;

FIG. 2 is an illustration of a selected vertebral area which was obtained by use of the posterior skinline;

FIG. 3 is an illustration of a straightened vertebral area, which was used for detecting vertebral edges;

FIG. 4 is an illustration of a line-enhanced image for visualization of vertebral edges;

FIG. 5 illustrates a computerized scheme for determination of the vertebral centerline;

FIG. 6 shows the relationship between a lateral width and the area of edge candidates, which were obtained from candidates detected at threshold levels from 2% to 10% of the histogram of the line-enhanced image;

FIG. 7 is an illustration of determining the centerline by use of multiple thresholding. The centerline is updated by use of detected vertebral-edge candidates, as the threshold level changes;

FIG. 8 illustrates a computerized scheme for detection of vertebral-edge candidates;

FIG. 9 shows the relationship between average local gradient and vertical distance along the vertebrae;

FIG. 10 shows the relationship between the distance from the centerline to the centroid of a vertebral-edge candidate and the angle between the candidate and the centerline;

FIGS. 11(a) and 11(b) show the relationship of the distance between the nearest candidates and the distance between the second-nearest candidates for (a) normal cases and (b) fracture cases;

FIGS. 12(a), 12(b), and 12(c) are an illustration of the straightened vertebral areas with no straightening, and after the first and second straightening processes, in which 12(a) shows the original image, 12(b) shows the straightened image obtained by first straightening, and 12(c) shows the straightened image obtained by 2nd straightening;

FIGS. 13(a) and 13(b) are an illustration of straightened vertebral area and detected vertebral-edge candidates (fractured vertebra is indicated by an arrow), in which 13(a) shows the second straightened image and 13(b) shows the detected vertebral-edge candidates, and FPE candidates appear below the diaphragm area;

FIG. 14 shows the relationship of the distance between the nearest candidates and the vertical distance along the vertebrae;

FIG. 15 shows the relationship between vertebral height and vertical distance along vertebrae, wherein the dotted line indicates estimated line of vertebral height concerning vertical distance along the vertebrae, and the arrow shows a fractured vertebra;

FIGS. 16(a) and 16(b) illustrate the determination of vertebral heights, including anterior height (Ha), middle height (Hm), and posterior height (Hp), and the three vertical lines are anterior line (left), middle line (middle), and posterior line (right), wherein 16(a) shows the detected vertebral-edge candidates on line enhanced image and 16(b) shows the determined vertebral heights;

FIGS. 17(a), 17(b), and 17(c) are an illustration of computer output indicating fractured vertebrae in three fracture cases, wherein the two arrowheads in 17(a) and 17(b) show correct detection of vertebral fractures, and the upper arrowhead in 17(c) shows correct detection of a vertebral fracture, and the lower arrowhead indicates a false positive detection;

FIG. 18 illustrates a lateral chest radiograph with a vertebral fracture which was detected correctly, as indicated by an arrowhead; and

FIG. 19 illustrates a system for detection of vertebral fractures according to an embodiment of the present invention.

### DETAILED DESCRIPTION OF THE PREFERRED EMBODIMENTS

One embodiment of a computerized scheme for detecting vertebral fractures is based on the detection of the upper and lower edges of vertebrae on lateral chest images, estimation of vertebral shape with detected vertebral edges, and identification of fractured vertebrae.

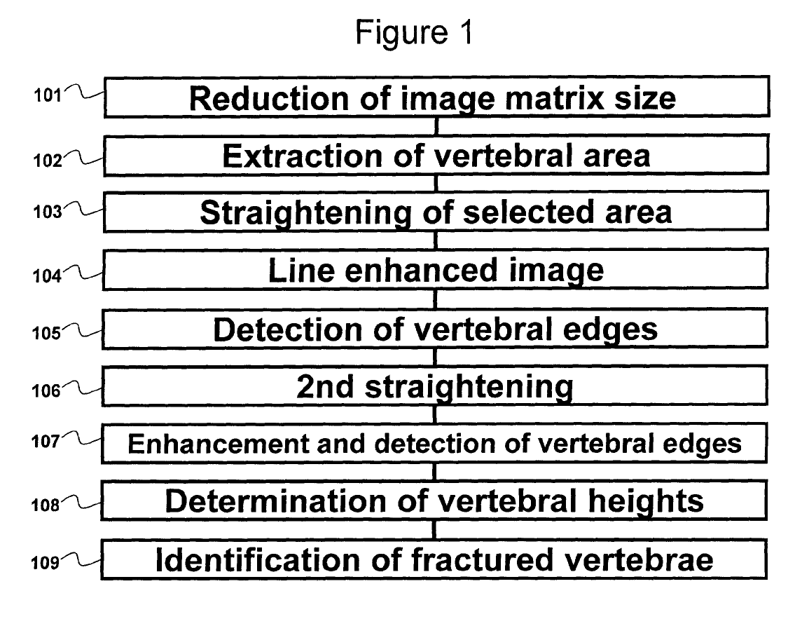

FIG. 1 illustrates one embodiment of the method. In this embodiment, the CAD scheme includes nine steps: (1) reduction of image matrix size, (2) extraction of a vertebral area by use of the posterior skinline, (3) straightening of the selected vertebral area, (4) creation of a line-enhanced image on the selected vertebral area, (5) detection of vertebral-edge candidates, (6) a second straightening by use of the vertebral centerline determined by the detected vertebral-edge candidates, (7) enhancement and detection of vertebral edges, (8) determination of vertebral heights, and (9) identification of fractured vertebrae. This new method was intended for identification of vertebral edges as accurately as possible and also for removal of false-positive edges by use of an iterative straightening scheme.

In step 101 of FIG. 1, an obtained medical image matrix size is reduced. For example, the image matrix size is reduced to 440×535 pixels. Other image sizes can be used and the original image, which is not reduced in matrix size, can be used as well.

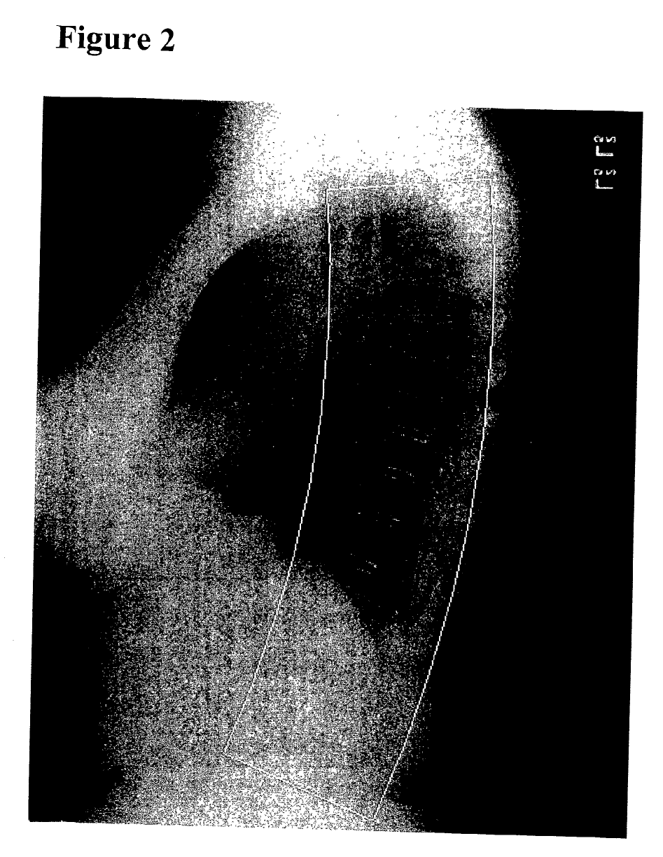

In step 102, a vertebral area (the curved area that includes a number of visible vertebrae) is identified automatically by use of the posterior skinline and is used as the search area for fractured vertebrae. The determination of a relatively small vertebral area can reduce the number of false positive candidates considerably. The posterior skinline in lateral chest radiographs is used for determining this area. The horizontal signatures from the posterior side of the lateral chest image are calculated with an interval of, e.g., 8 mm from the top to the bottom of the lateral chest image, and the locations with the maximum edges are determined as parts of the skinline. The locations are then fitted by a 2nd-order polynomial function by use of a least-square method. It is not necessary that the locations be fitted by a 2nd-order polynomial function; other functions can be used as well including other higher polynomials. The curved line is determined as the posterior skinline, which is shifted horizontally for estimation of the vertebral centerline. The vertebral area is determined by use of the centerline, as illustrated in FIG. 2.

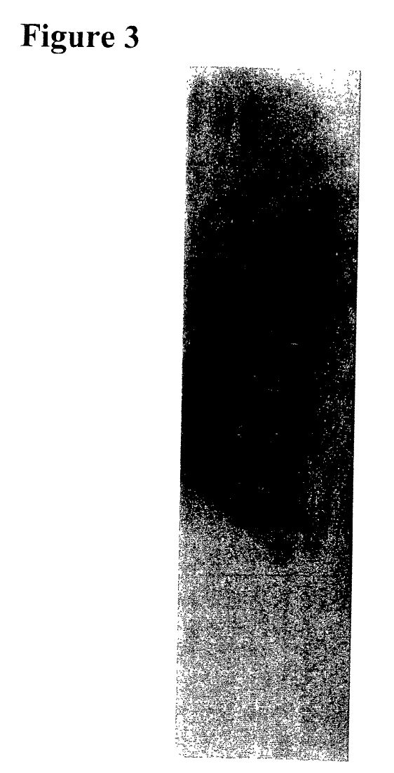

In step 103, the selected vertebral area is then straightened such that the upper and lower edges of the vertebrae are oriented horizontally. Therefore, the subsequent detection of vertebral edges becomes relatively simple. For straightening of the selected area, a localized adaptive linear interpolation method is used. The selected vertebral area is divided into small quadrilateral areas, which are converted to rectangular regions by use of the linear interpolation technique, as shown in FIG. 3. Note that it is difficult to detect correctly vertebral edges located in the upper lung areas and near the lumbar spine when vertebral edges are detected without straightening. In order to detect vertebral edges without straightening, it would be necessary to employ a complex edge detection method by taking into account the orientation of edges in all directions, which could potentially produce a large number of false positives.

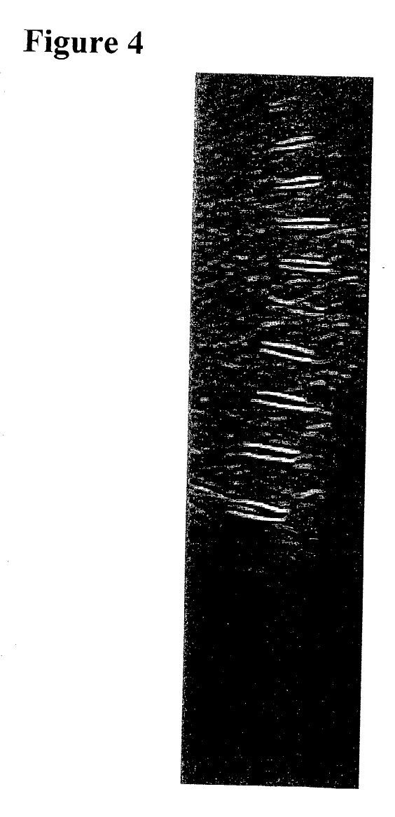

In step 104, line components in the straightened image are enhanced for detection of vertebral edges by use of a line-enhancement filter [31]. Only the kernel with which the horizontal line components can be enhanced is used, because the vertebral edges are expected to be oriented nearly horizontally by the straightening of the vertebral area. A line-enhanced image is shown in FIG. 4, in which the vertebral edges are clearly enhanced. Additionally, vertebral edges can be enhanced by other methods, such as line-components enhancement by use of a Hessian matrix, a morphological filter by use of structuring element which can be enhanced line components, or a directional band pass filter.

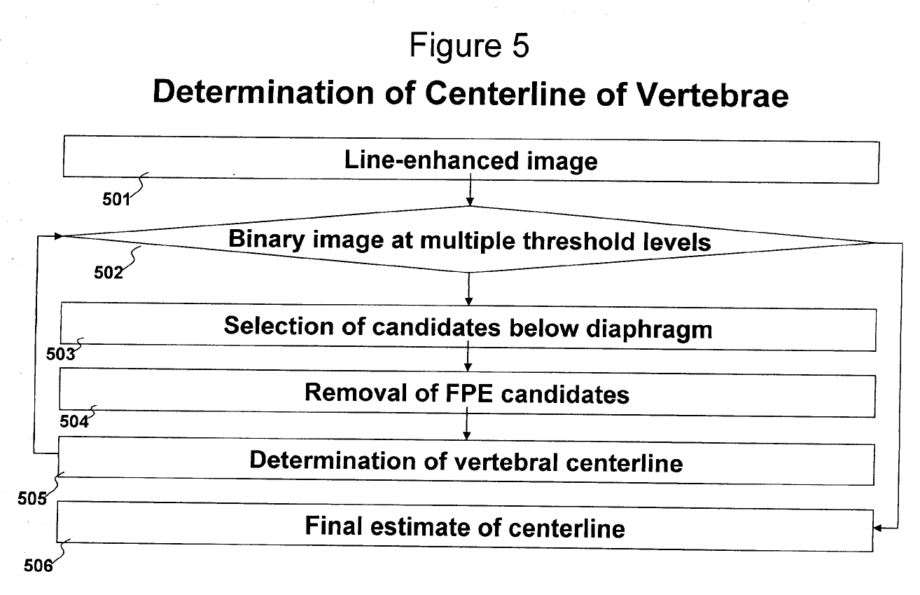

The vertebral centerline is determined by the method as shown in FIG. 5. In step 501, the vertebral centerline is determined in order to eliminate false vertebral-edge candidates, which correspond to false positive edges (hereinafter FPEs). The majority of FPEs are mainly due to vertebral notches and blood vessels in the lung areas; vertebral notches are located in the posterior side of the vertebral edges, and most blood vessels in the anterior side. To determine the centerline, in step 502, vertebral-edge candidates are identified using a multiple thresholding technique followed by image feature analysis. The initial threshold is selected at the pixel value corresponding to the top 2% of the histogram of the line-enhanced image. In step 503, the lateral width and the area of candidates are used as feature values, and in step 504, candidates with short or long lateral width (and small or large area) are eliminated as FPEs. In step 505, the vertebral centerline is determined by using the left and right edges of all detected candidates. The centerline is estimated with the 2nd-order polynomial function by use of a least square method. Additionally, the centerline can be estimated by use of other functions such as higher order polynomials.

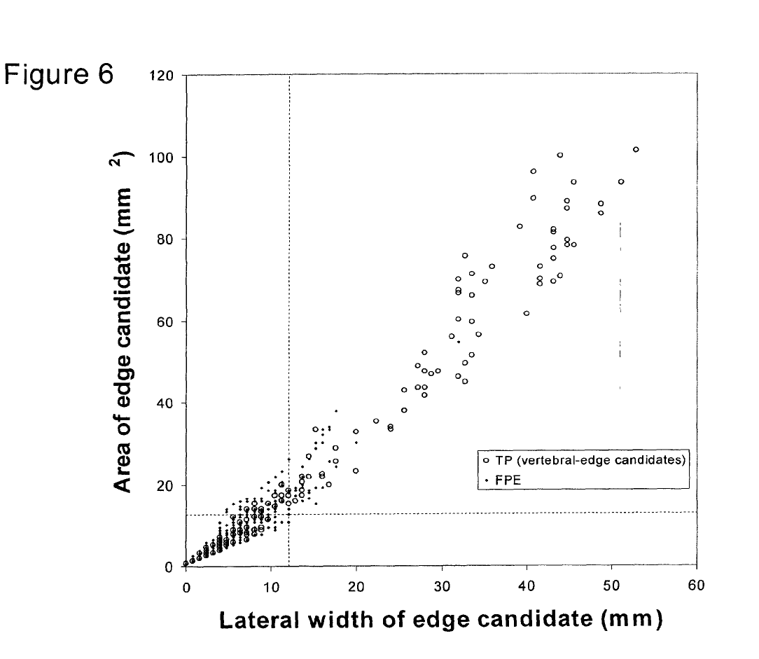

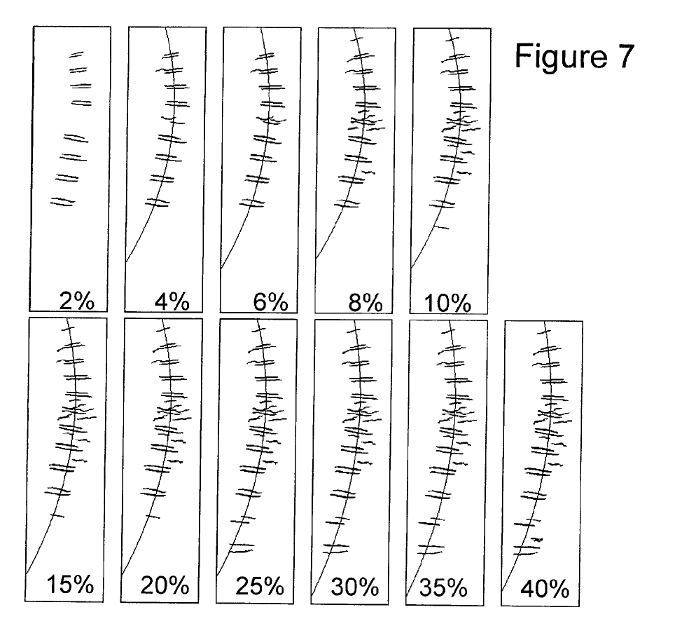

Step 502 is then repeated and the second threshold corresponding to 4% in the histogram of the line-enhanced image is used for determining edge candidates again. In this step, candidates with a large distance between the centerline and the centroid of a candidate as FPEs are eliminated. In addition candidates with short lateral width (and small area) are also elminated. The same procedure is repeated at thresholds of 6, 8, 10, 15, 20, 25, 30, 35, and 40% in the histogram of the line-enhanced image. In step 503, the thresholds corresponding to 15, 20, 25, 30, 35, and 40% in the histogram are applied only to edge candidates below the diaphragm. FIG. 6 shows the relationship between the lateral width and the area of detected candidates at the threshold levels from 2% to 10%. In step 504, candidates below the dotted lines at each feature value are eliminated as FPEs. Some TP candidates are eliminated in this graph, but almost all of these eliminated TP candidates are detected subsequently at the upper threshold level. In step 505, the centerline is revised with additional candidates detected as the threshold level increased from 2% to 40%, as shown in FIG. 7. In step 506, the final estimate of the centerline is obtained at the threshold level of 40%.

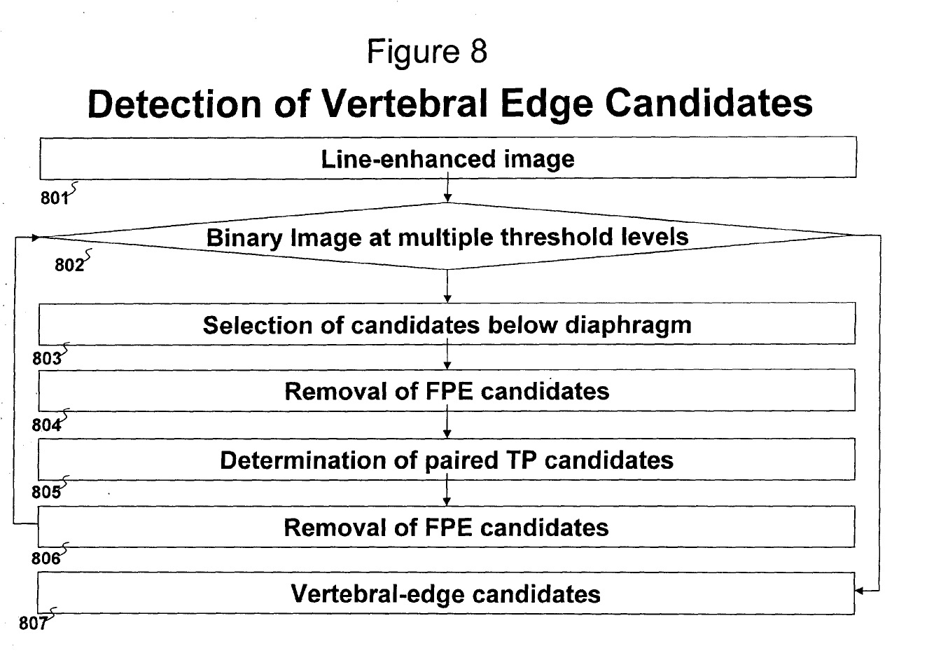

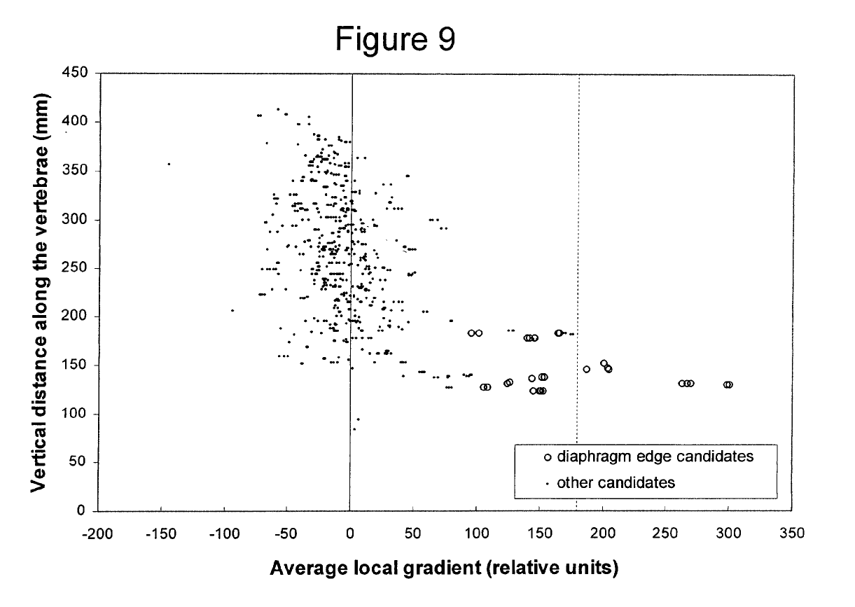

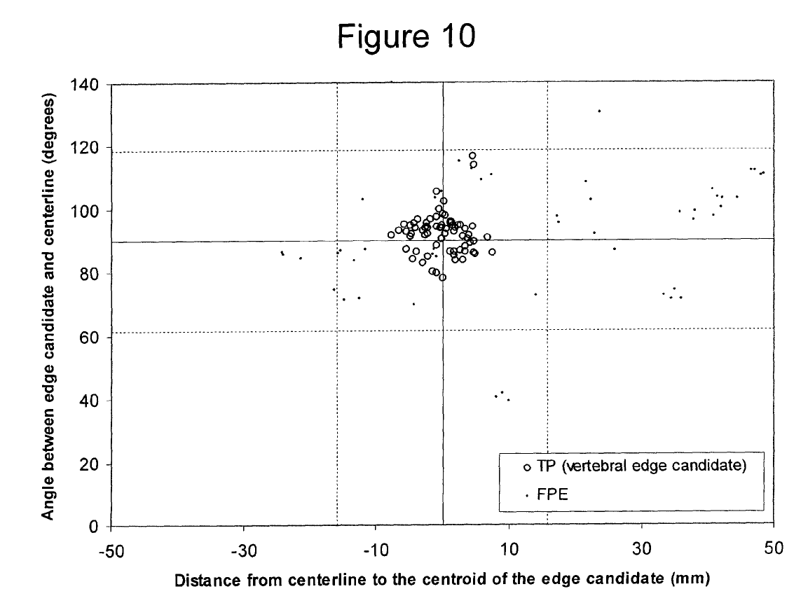

Step 105 is illustrated in FIG. 8, which shows the scheme for determining vertebral-edge candidates by use of the multiple thresholding technique followed by feature analysis. In step 802, threshold levels corresponding to 2, 4, 6, 8, 10, 15, 20, 25, 30, 35, and 40% in the histogram of pixel values of the line-enhanced image were used for producing binary images. In step 803, edge candidates are selected by analyzing features extracted from binary images. The features include, for example, the lateral width, the area, the distance between the vertebral centerline and the centroid of the candidate, the angle between the vertebral centerline and the candidate, and the average local gradient. The average local gradient is used for distinction between the vertebral-edge candidates and the diaphragm edge. In step 804, the average pixel values in the upper and lower area of the candidate are calculated, and candidates with a large difference in these average pixel values are eliminated as diaphragm edges. For identification of diaphragm edges, FIG. 9 shows the relationship between the average local gradient and the vertical distance along the vertebrae. Diaphragm edge candidates are located at the lower right area with large average gradients. FIG. 10 shows the relationship between the distance from the vertebral centerline to the centroid of the edge candidate and the angle between the vertebral centerline and the edge candidate. The majority of vertebral-edge candidates are located near the centerline in the horizontal direction. Candidates due to vertebral notches appear on the right side of the vertebral edges, and candidates due to blood vessels in lung areas appear on the left side of vertebral edges. A rule-based method is applied using these feature values for removal of FPE candidates. The thresholds used with this method are shown as dotted lines in FIGS. 9 and 10.

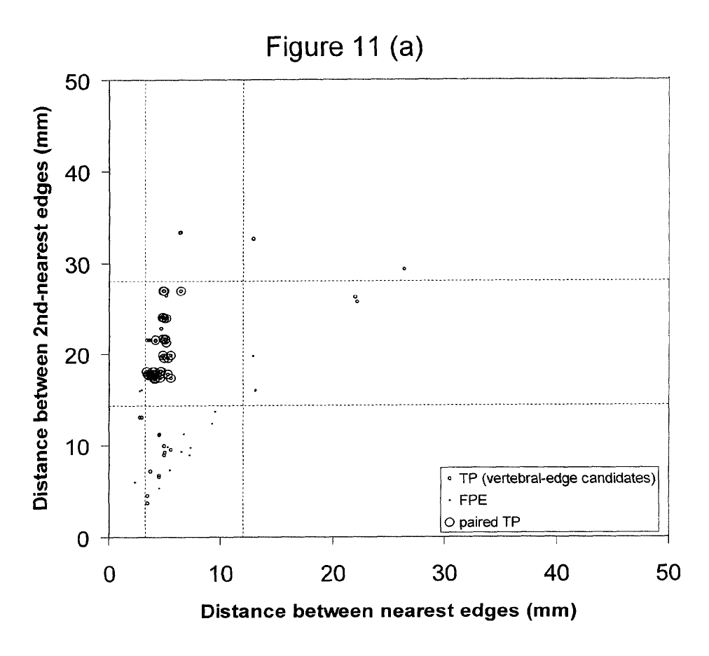

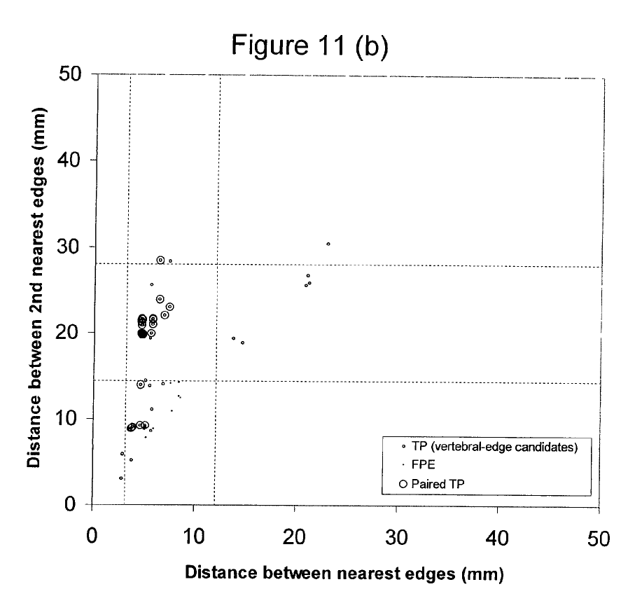

In step 805, paired candidates are identified for further elimination of some of the FPE candidates. Paired candidates indicate a set of nearby vertebral edges, which generally correspond to the upper and lower part of a vertebral disk space. To identify paired candidates, the distance between the nearest candidates and the distance between the second nearest candidates are determined. The distance between the nearest candidates indicates the distance of a vertebral disk space, and the distance between the second nearest edge candidates indicates the height of a vertebra, when vertebral edges are detected correctly. In step 806, a vertebral-edge candidate can be eliminated as FPE, when the candidate is located between two paired candidates, each as separate paired candidates. FIGS. 11(a) and 11(b) show the relationship of the distance between the nearest edge candidates and the distance between the second nearest edge candidates. In normal cases, as shown in FIG. 11(a), paired candidates detected correctly are located in a small rectangular area, which is surrounded by dotted lines. Some paired candidates for fracture cases in FIG. 11(b) are located below the area surrounded by dotted lines. In step 807, the candidates are found to be vertebral-edge candidates. These candidates may be related to fractured vertebrae, because the second-nearest distance is short. In this case, three paired candidates are related to fractured vertebrae.

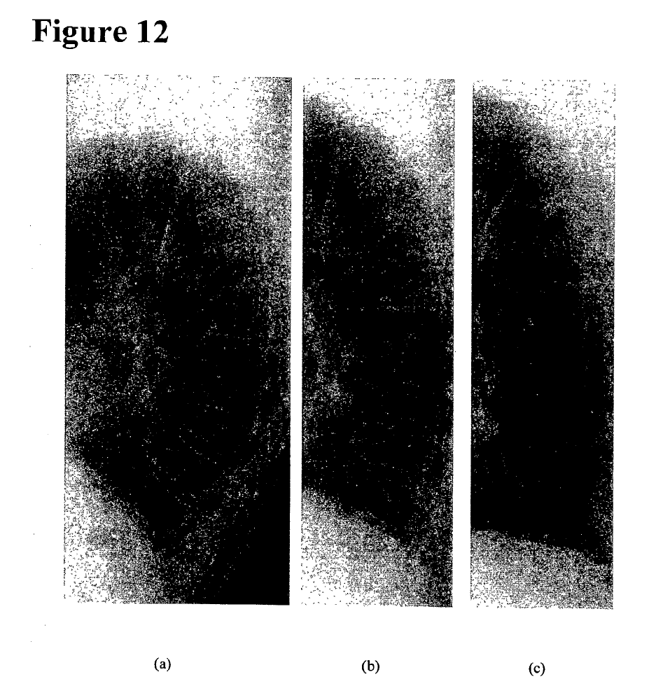

In step 106, the final estimate of the centerline for vertebral edges is applied to a second straightening for obtaining more accurate alignment of vertebrae, because in some cases, the vertebral area is not straightened adequately with the first straightening method. FIG. 12 shows that the second straightening can improve the accuracy of straightening.

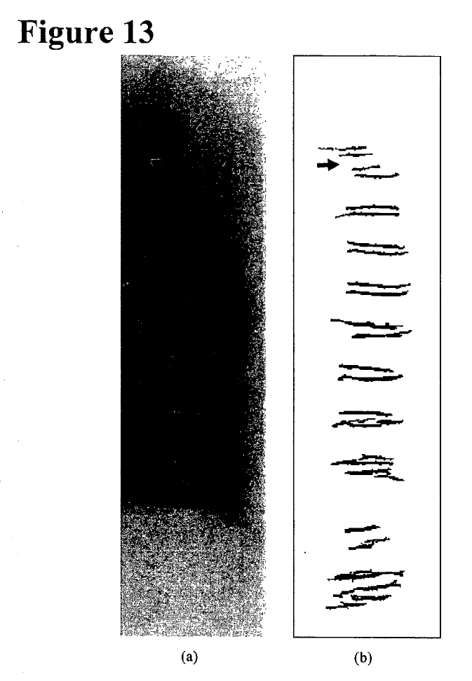

In step 107, candidates for vertebral edges are detected again by repetition of the line enhancement, multiple thresholding, and subsequent feature analysis. Candidates detected at the first straightening and second straightening at each threshold level are superimposed. FIG. 13 shows a non-limiting example of detected vertebral-edge candidates, with an arrow indicating a fractured vertebra.

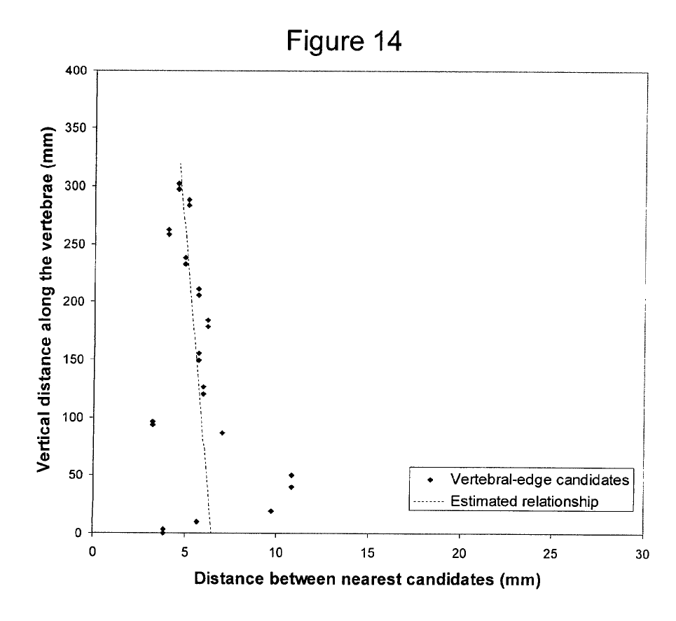

When a lateral radiograph is taken with a patient in an oblique position relative to the incident x-ray beam, a vertebral edge may be visualized as two vertebral edges. In this non-limiting example, two edge candidates are located very close to each other, and these edge candidates can become a pair. However, a proper paired candidate should have the distance corresponding to the vertebral disk space. Therefore, re-evaluation of paired candidates is required. Paired candidates are again examined for increasing the accuracy in the determination of paired candidates and for further elimination of some of FPE candidates. FIG. 14 shows the relationship between the distance for the nearest candidates and the vertical distance along the vertebrae. Candidates with the nearest distance less than 12 mm are retained as paired candidates, which can be identified by two adjacent points with the same nearest distance in FIG. 14, whereas those with a 12 mm or larger distance are removed. To identify incorrect paired candidates, the average distance for properly paired candidates is estimated by use of a straight line (dotted line). A paired candidate with the nearest distance which was much shorter than the average distance represented by the straight line is removed. However, if a non-paired, isolated edge candidate is located close to the paired candidate with a very short distance, then these three edge candidates are examined to see whether a different combination for pairing might provide correctly paired candidates. Additionally, candidates which are not paired are removed as FPEs.

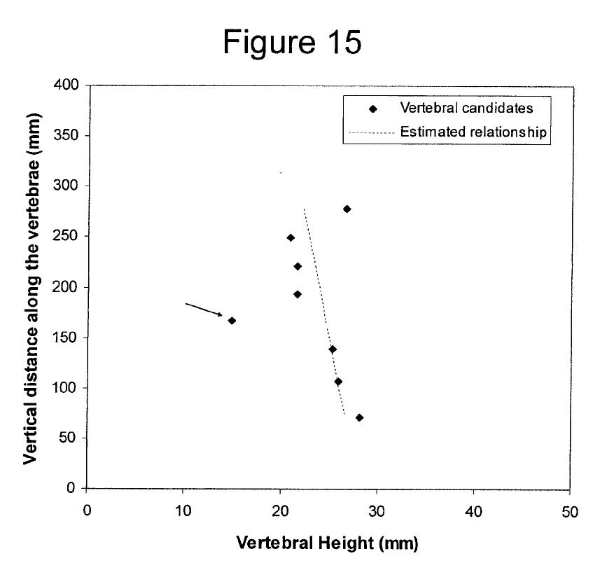

Three methods for determination of fractured vertebrae are examined. The first method found is based on the detected vertebral edges. It was found that there is an approximately linear relationship between the vertebral height and the location of the vertebra. Therefore, in step 108, the estimated vertebral heights are determined by use of the detected location of vertebral-edge candidates. FIG. 15 shows the relationship between the vertebral height and the distance along the vertebrae. In step 109, a candidate whose height is less than 70% of the estimated height is considered to be a fractured vertebra, as indicated by an arrow. Additionally, the relationship between the vertebral height and the location of the vertebra can be estimated by non linear functions such as polynomial functions.

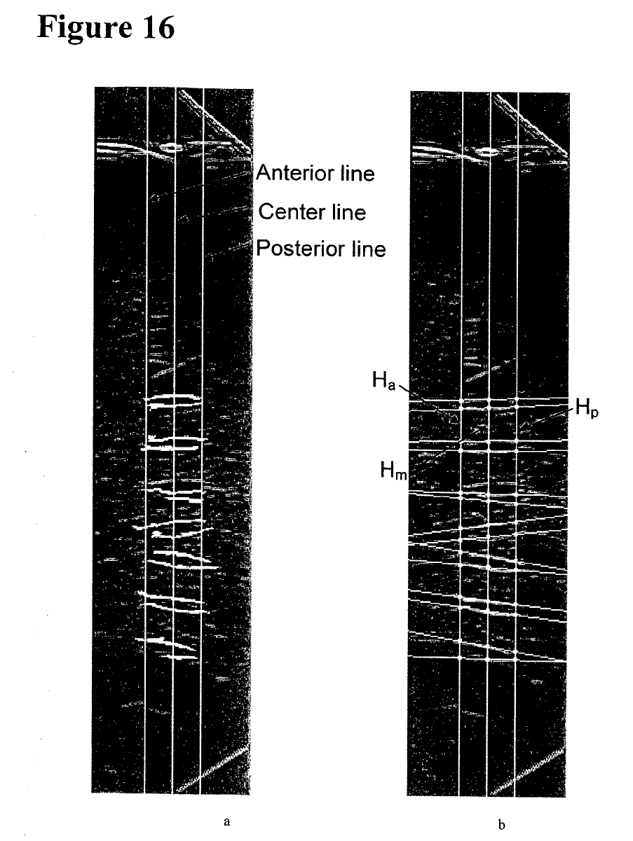

The second method is based on an analysis of the shape of the vertebrae. The vertebral heights determined from the detected vertebral edges are used to characterize the shape of the vertebrae and to distinguish fractured from normal vertebrae. Vertebral heights are obtained from six points, which include the anterior upper edge, anterior lower edge, middle upper edge, middle lower edge, posterior upper edge, and posterior lower edge. The anterior vertebral line, middle vertebral line, and posterior vertebral line are determined by approximation of the candidates' anterior locations, middle locations, and posterior locations, respectively as shown in FIG. 16. The intersection of these vertical lines with horizontal lines approximating the detected vertebral edges indicate six points, including the anterior upper edge, anterior lower edge, etc. Vertebral heights such as the anterior height, middle height, and posterior height are determined by use of the anterior upper edge, anterior lower edge, etc. as shown in FIG. 16. The average vertebral height for a given case is determined, and vertebrae with significantly small heights are considered to have undergone vertebral fractures.

The third method for determining vertebral fractures is based on the vertebral height ratio, such as ratios of Hₐ/Hₚ, Hₘ/Hₚ, and Hₚ/average Hₚ of adjacent vertebrae, where these ratios are obtained from the anterior height (Hₐ), middle height (Hₘ) and posterior height (Hₚ). The six points determined are converted to the corresponding locations in the original image, and height ratios are calculated. Only Hₐ/Hₚ and Hₚ/average Hₚ of adjacent vertebrae were used. Candidates with a ratio of Hₐ/Hₚ less than 0.7 are considered to be fractured vertebrae.

In a study of an embodiment of the present invention, the database of medical images 1907 included 1,000 lateral chest radiographs of patients 65 years or older (437 male, 563 female; mean age, 76 years) with and without vertebral fractures. The images use a computed radiography system (Fuji Photo Film Co.) with the patient in the upright position. The digital images have a matrix size of 1,760×2,140 with 1,024 gray levels and are shown on an image display 1906. The exclusion criteria for inappropriate lateral chest images are (1) very poor image quality, (2) technical errors, and (3) more than one lateral chest radiograph of the same patient. The presence or absence of a vertebral fracture is established by the consensus of two radiologists based on subjective judgments by use of a method proposed by Genant et al. [30].

All visible vertebrae are classified into normals (non-fracture cases), and fractures of grade 1, grade 2, and grade 3. For example, the lateral chest images might include about 30% normals, 40% grade 1, 15% grade 2, and 5% grade 3, as well as 10% others (excluded cases). In addition, radiologists subjectively provide morphometric data, i.e., six edge points indicating the anterior upper edge, anterior lower edge, middle upper edge, middle lower edge, posterior upper edge, and posterior lower edge. The average locations of vertebral edges are determined by three radiologists as a “gold standard”. The vertebral edge areas used as “truth” for correct locations of vertebral edges are determined by connecting of three points for the upper edges and three other points for the lower edges, which correspond to the “gold standard”. For evaluation of the computer output from this CAD scheme, edge candidates which overlap with these vertebral edge areas are considered to be true positive (TP) candidates.

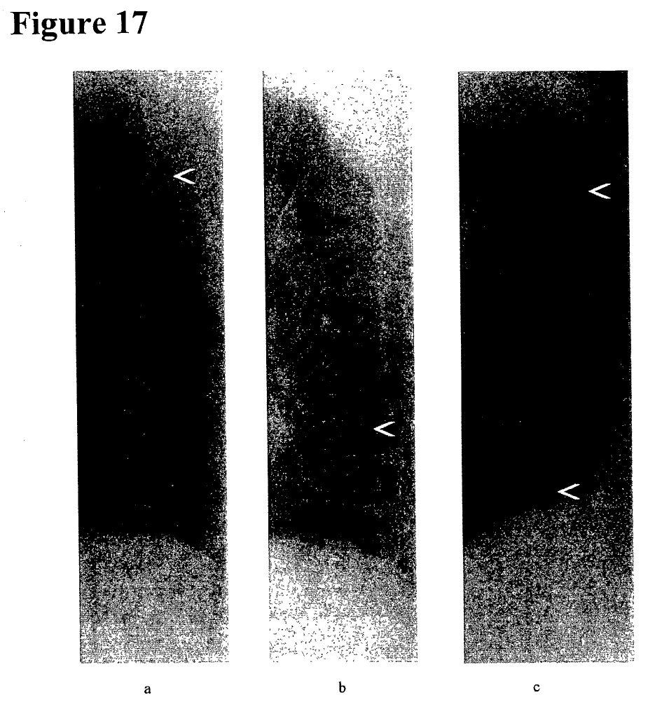

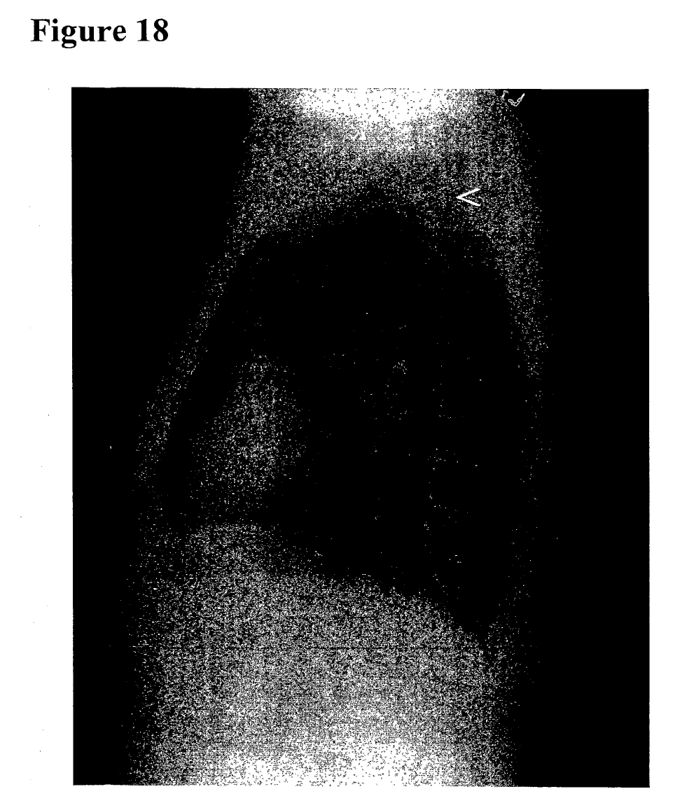

FIG. 17 shows an example of three straightened images with vertebral fractures, in which three fractured vertebrae are detected correctly indicated by arrowheads. In the non-limiting example, among three fractured cases, including four fractured vertebrae, and three normal cases, the computerized method is able to detect three fractured vertebrae in all fracture cases, including one false positive, i.e., 0.17 false positive detection per image. However, there is no false positive detection of fractured vertebrae in the three normal cases. Another method based on analysis of the shape of the vertebrae provides the same result. With the method based on the vertebral height ratio, three fractured cases with three fractured vertebrae are correctly detected, with four false-positives, i.e., 0.66 (4/6) false positive detection per image, including one false positive detection of fractured vertebrae in the three normal cases. FIG. 18 shows a lateral chest radiograph with a fractured vertebra which was detected correctly, as indicated by an arrowhead.

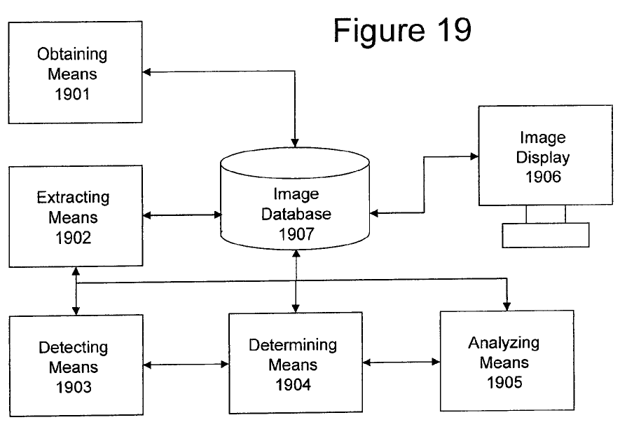

FIG. 19 illustrates a system configured to implement the detection of vertebral fractures.

The image obtaining means 1901 is configured to obtain a medical image including a plurality of vertebrae. For example the medical image could be lateral chest radiograph. The extracting means 1902 is configured to extract a vertebral area including the plurality of vertebra in the obtained medical image based on a determined posterior skinline. The detecting means 1903 is configured to detect in the vertebral area, corresponding edges of the plurality of vertebra using line enhancement and multiple thresholding. The determining means 1904 is configured to determine the vertebral height of each vertebra based on the location of the detected edges of the vertebra. Finally, the analyzing means 1905 is configured to determine the vertebral heights to identify fractured vertebra.

For the purposes of this description we shall define an image to be a representation of a physical scene, in which the image has been generated by some imaging technology: examples of imaging technology could include television or CCD cameras or X-ray, sonar or ultrasound imaging devices. The initial medium on which an image is recorded could be an electronic solid-state device, a photographic film, or some other device such as a photostimulable phosphor. That recorded image could then be converted into digital form by a combination of electronic (as in the case of a CCD signal) or mechanical/optical means (as in the case of digitizing a photographic film or digitizing the data from a photostimulable phosphor). The number of dimensions which an image could have could be one (e.g. acoustic signals), two (e.g. X-ray radiological images) or more (e.g. nuclear magnetic resonance images).

All embodiments of the present invention conveniently may be implemented using a conventional general purpose computer or micro-processor programmed according to the teachings of the present invention, as will be apparent to those skilled in the computer art. Appropriate software may readily be prepared by programmers of ordinary skill based on the teachings of the present disclosure, as will be apparent to those skilled in the software art.

A computer 900 may implement the methods of the present invention, wherein the computer housing houses a motherboard which contains a CPU, memory (e.g., DRAM, ROM, EPROM, EEPROM, SRAM, SDRAM, and Flash RAM), and other optional special purpose logic devices (e.g., ASICS) or configurable logic devices (e.g., GAL and reprogrammable FPGA). The computer also includes plural input devices, (e.g., keyboard and mouse), and a display card for controlling a monitor. Additionally, the computer may include a floppy disk drive; other removable media devices (e.g. compact disc, tape, and removable magneto-optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

Examples of computer readable media associated with the present invention include compact discs, hard disks, floppy disks, tape, magneto-optical disks, PROMs (e.g., EPROM, EEPROM, Flash EPROM), DRAM, SRAM, SDRAM, etc. Stored on any one or on a combination of these computer readable media, the present invention includes software for controlling both the hardware of the computer and for enabling the computer to interact with a human user. Such software may include, but is not limited to, device drivers, operating systems and user applications, such as development tools. Computer program products of the present invention include any computer readable medium which stores computer program instructions (e.g., computer code devices) which when executed by a computer causes the computer to perform the method of the present invention. The computer code devices of the present invention may be any interpretable or executable code mechanism, including but not limited to, scripts, interpreters, dynamic link libraries, Java classes, and complete executable programs. Moreover, parts of the processing of the present invention may be distributed (e.g., between (1) multiple CPUs or (2) at least one CPU and at least one configurable logic device) for better performance, reliability, and/or cost. For example, an outline or image may be selected on a first computer and sent to a second computer for remote diagnosis.

The present invention may also be complemented with additional filtering techniques and tools to account for image contrast, degree of irregularity, texture features, etc.

The invention may also be implemented by the preparation of application specific integrated circuits or by interconnecting an appropriate network of conventional component circuits, as will be readily apparent to those skilled in the art.

The source of image data to the present invention may be any appropriate image acquisition device such as an X-ray machine, CT apparatus, and MRI apparatus. Further, the acquired data may be digitized if not already in digital form. Alternatively, the source of image data being obtained and processed may be a memory storing data produced by an image acquisition device, and the memory may be local or remote, in which case a data communication network, such as PACS (Picture Archiving Computer System), may be used to access the image data for processing according to the present invention.

Numerous modifications and variations of the present invention are possible in light of the above teachings. For example, the invention may be applied to images other than MRA images.

Of course, the particular hardware or software implementation of the present invention may be varied while still remaining within the scope of the present invention. It is therefore to be understood that within the scope of the appended claims and their equivalents, the invention may be practiced otherwise than as specifically described herein.

1. A computer-implemented method of detecting vertebral fractures, comprising:
obtaining a medical image including a plurality of vertebrae;
detecting, corresponding edges of the plurality of vertebra using line enhancement and feature analysis;
determining the vertebral height of each vertebra based on a location of the detected edges of the vertebra; and
analyzing the determined vertebral heights to identify fractured vertebra.

2. The method of claim 1, wherein the obtaining step comprises:
obtaining a lateral chest radiograph as the medical image; and
reducing a size of the medical image.

3. The method of claim 1, wherein the detecting step comprises:
straightening the vertebral area so that an upper and lower edge of the vertebra are oriented horizontally.

4. The method of claim 3, further comprising:
repeating the detecting, straightening, and determining steps.

5. The method of claim 1, wherein the detecting step comprises:
determining a vertebral centerline of each vertebra using left and right edges of each vertebra.

6. The method of claim 5, wherein the detecting step comprises:
analyzing at least one of a lateral width, area, distance between the vertebral centerline and a centroid of each vertebra, angle between the vertebral centerline and each vertebra, and an average local gradient; and
reducing false positive edges using paired detected edges of each vertebra.

7. The method of claim 1, wherein the analyzing step comprises:
determining a linear relationship between the determined vertebral heights and a location of each vertebra using least squares analysis; and
identifying the fractured vertebra as those vertebra having a height less than a predetermined percentage of an estimated height based on the determined linear relationship.

8. The method of claim 1, wherein the determining step comprises:
determining an anterior vertebral line, a middle vertebral line, and a posterior vertebral line based on the locations of the detected edges of the vertebra;
determining, for each vertebra, an anterior upper edge, an anterior lower edge, a middle upper edge, a middle lower edge, a posterior upper edge, and a posterior lower edge using the determined lines and the vertebral edges;
determining, for each vertebra, an anterior height (Hₐ), a middle height (Hₘ), and a posterior height (Hₚ) using the respective upper and lower edges; and
averaging, for each vertebra, the determined anterior height, middle height, and posterior height to obtain the vertebral height of the vertebra.

9. The method of claim 8, wherein the determining step comprises:
determining, for each vertebra, the ratios Hₐ/Hₚ, Hₘ/Hₚ, and Hₚ/average Hₚ, wherein average Hₚ is determined by averaging the determined posterior heights of adjacent vertebrae.

10. The method of claim 1, further comprising:
determining a vertebral area and detecting vertebral edges in said vertebral area.

11. The method of claim 1, further comprising:
determining said vertebral area by use of posterior skinline, and detecting vertebral edges in said vertebral area.

12. A computer program product embedded on a computer readable medium, the computer program product including plural computer program instructions which, when executed by a computer, cause the computer to perform a method including the following steps:
obtaining a medical image including a plurality of vertebrae;
detecting, corresponding edges of the plurality of vertebra using line enhancement and feature analysis;
determining the vertebral height of each vertebra based on a location of the detected edges of the vertebra; and
analyzing the determined vertebral heights to identify fractured vertebra.

13. The computer program product of claim 12, wherein the obtaining step comprises:
obtaining a lateral chest radiograph as the medical image; and
reducing a size of the medical image.

14. The computer program product of claim 12, wherein the detecting step comprises:
straightening the vertebral area so that an upper and lower edge of the vertebra are oriented horizontally.

15. The computer program product of claim 14, further comprising:
repeating the detecting, straightening, and determining steps.

16. The computer program product of claim 12, wherein the detecting step comprises:
determining a vertebral centerline of each vertebra using left and right edges of each vertebra.

17. The computer program product of claim 16, wherein the detecting step comprises:
analyzing at least one of a lateral width, area, distance between the vertebral centerline and a centroid of each vertebra, angle between the vertebral centerline and each vertebra, an average local gradient; and
reducing false positive edges using paired detected edges of each vertebra.

18. The computer program product of claim 12, wherein the analyzing step comprises:
determining a linear relationship between the determined vertebral heights and a location of each vertebra using least squares analysis; and
identifying the fractured vertebra as those vertebra having a height less than a predetermined percentage of an estimated height based on the determined linear relationship.

19. The computer program product of claim 12, wherein the analyzing step comprises:
determining an anterior vertebral line, a middle vertebral line, and a posterior vertebral line based on the locations of the detected edges of the vertebra;
determining, for each vertebra, an anterior upper edge, an anterior lower edge, a middle upper edge, a middle lower edge, a posterior upper edge, and a posterior lower edge using the determined lines and the vertebral edges;
determining, for each vertebra, an anterior height (Hₐ), a middle height (Hₘ), and a posterior height (Hₚ) using the respective upper and lower edges; and
averaging, for each vertebra, the determined anterior height, middle height, and posterior height to obtain the vertebral height of the vertebra.

20. The computer program product of claim 12, wherein the analyzing step comprises:
determining, for each vertebra, the ratios Hₐ/Hₚ, Hₘ/Hₚ, and Hₚ/average Hₚ, wherein average Hₚ is determined by averaging the determined posterior heights of adjacent vertebrae.

21. The computer program product of claim 12, further comprising:
determining a vertebral area and detecting vertebral edges in said vertebral area.

22. The computer program product of claim 12, further comprising:
determining said vertebral area by use of posterior skinline, and detecting vertebral edges in said vertebral area.

23. A computer-implemented system configured to detect vertebral fractures, comprising:
means for obtaining a medical image including a plurality of vertebrae;
means for detecting, corresponding edges of the plurality of vertebra using line enhancement and feature analysis;
means for determining the vertebral height of each vertebra based on a location of the detected edges of the vertebra; and
means for analyzing the determined vertebral heights to identify fractured vertebra.

24. The computer-implemented system of claim 23, further comprising:
means for determining a vertebral area and means for detecting vertebral edges in said vertebral area.

25. The computer-implemented system of claim 23, further comprising:
means for determining said vertebral area by use of posterior skinline, and means for detecting vertebral edges in said vertebral area.
